(19) United States
(12) Patent Application Publication
(10) Pub. No.: US 2021/0023660 A1
(43) Pub. Date: Jan. 28, 2021

(54) APPARATUS FOR REPAIRING WHEEL TREAD WITH MATERIAL INCREASE

(71) Applicant: Yanshan University, Hebei (CN)

(72) Inventors: Yonggang Dong, Hebei (CN); Pengfei Zhao, Hebei (CN); Yikun Zhao, Hebei (CN); Jiabin Luan, Hebei (CN); Shuai Yi, Hebei (CN)

(73) Assignee: Yanshan University, Hebei (CN)

(21) Appl. No.: 16/928,488

(22) Filed: Jul. 14, 2020

(30) Foreign Application Priority Data
Jul. 22, 2019 (CN) 201910660082.5

(51) Int. Cl. B23P 6/00

(52) U.S. Cl. CPC B23P 6/00; B23P 2700/14

(57) ABSTRACT

The invention discloses an apparatus for repairing wheel tread with material increase, which comprises a slide rail, a rack, a case, a supporting device, a drive device, a wheel heating device, an ingot blank heating device and an agitation and output device; the rack is fixedly arranged above the slide rail, an upper end of the case is fixedly connected to an upper portion of the rack, the supporting device and drive device are both slidably connected to the slide rail, an output end of the drive device is fixedly connected to the wheels which are positioned below a semicircular notch and are located eccentrically relative to the semicircular notch. The wheel heating device is fixedly arranged below the case, the ingot blank heating device and the agitation and output device are both fixedly arranged in the case, the ingot blank heating device is communicated with the agitation.

### CROSS REFERENCE TO RELATED APPLICATION

This application claims the priority of Chinese Patent Application No. CN201910660082.5, entitled “APPARATUS FOR REPAIRING WHEEL TREAD WITH MATERIAL INCREASE”, filed with the Chinese Patent Office on Jul. 22, 2019, which is incorporated herein by reference in its entirety.

### TECHNICAL FIELD

The invention relates to the technical field of repairing wheels of multiple units, in particular to an apparatus for repairing wheel tread with material increase.

### BACKGROUND ART

As a mass of multiple units run at a high-speed in China, a problem of wheelset wear is increasingly outstanding. The wheelset of a high-speed train bears a great fluctuation of load during running at the high-speed, so as to easily cause damage of tread. After the wheel tread of the high-speed train is worn, various dynamic performances also reduce in different degrees, influencing the safe running of the train. In order to improve the safety and the comfort of train running, it is necessary to repair the wear of the wheel tread in time. At present, methods such as periodically repairing the wheelset by turning and grinding steel rails are commonly employed by various countries to treat the wear damage of wheel to restore the wheelset to a reference profile, so as to improve the dynamic performances of a vehicle system and ensure the safety and comfort of vehicle running. However, the conventional turning repair of wheel wastes a lot of manpower, material and financial resources, and an increase in the number of repairing the wheel by turning results in the wheel becoming undersize and being scrapped.

### SUMMARY OF THE INVENTION

The invention aims to provide an apparatus for repairing wheel tread with material increase, to solve the above problems existing in the prior art, the apparatus can avoid the size of the wheels from becoming smaller and being scrapped due to repairing the wheels, is beneficial to save materials, and is time-saving and labor-saving since the repair process is automatically carried out.

In order to achieve the above purpose, the invention provides the following scheme:

The invention provides an apparatus for repairing wheel tread with material increase, comprises a slide rail, a rack, a case, a supporting device, a drive device, a wheel heating device, an ingot blank heating device and an agitation and output device; the slide rail is fixedly arranged on a ground, the rack is fixedly arranged above the slide rail, an upper end of the case is fixedly connected to an upper portion of the rack, the supporting device for supporting wheels and the drive device are both slidably connected to the slide rail, an output end of the drive device is fixedly connected to the wheels to drive the wheels to rotate; the wheels are positioned below a semicircular notch formed in a lower portion of the case, and are located eccentrically relative to the semicircular notch; the wheel heating device is fixedly placed below the case and is used for heating a worn portion of the wheels, the ingot blank heating device and the agitation and output device are both fixedly arranged in the case, the ingot blank heating device is used for heating an ingot blank and is communicated with the agitation and output device for agitating slurry and extruding the slurry in a semisolid state toward the worn portion of the wheels.

Preferably, the supporting device comprises a base connected slidably to the slide rail, a pedestal bearing arranged fixedly on the base, and a transmission shaft, one end of the transmission shaft is engaged with the pedestal bearing by an interference fit, the wheels is fixedly arranged on the transmission shaft, another end of the transmission shaft fixedly connected to output end of the drive device.

Preferably, the supporting device further comprises a handle and screws, the handle is fixedly connected to a front portion of the base through the screws.

Preferably, the drive device comprises a motor support connected slidably to the slide rail, a motor arranged fixedly on the motor support, and a coupler, a motor shaft of the motor is fixedly connected to one end of the coupler, and another end of the coupler is fixedly connected to one end of the transmission shaft far away from the pedestal bearing.

Preferably, the wheel heating device is a laser heating device.

Preferably, the ingot blank heating device is a heating furnace.

Preferably, the agitation and output device comprises a agitation and extrusion tank, a agitation and extrusion threaded rod and a agitation drive device; the agitation and extrusion tank and the agitation drive device are both fixedly arranged in the case, the agitation and extrusion threaded rod is fixedly arranged inside the agitation and extrusion tank, and is connected with the agitation drive device for driving the agitation and extrusion threaded rod to rotate, a bottom surface of the agitation and extrusion tank defines an extrusion port, an upper surface of the semicircular notch defines a discharge port located a position corresponding to the extrusion port.

Preferably, the agitation drive device comprises an agitation motor connected fixedly with an input end of a gearbox and the gearbox, an output end of the gearbox is fixedly connected to the agitation and extrusion threaded rod.

Preferably, the apparatus further comprises an adjusting device including studs, positioning nuts and support springs, one end of the studs are fixedly connected to an outer top surface of the case, an upper portion of rack defines bolt holes through which a free end of the studs threadedly connected to the positioning nuts passes, one end of support springs are fixedly connected to a crossbeam located at a middle of the rack, and another end of which are used for being in contact with connection blocks arranged fixedly on the case.

Preferably, the apparatus for repairing wheel tread with material increase further comprises foundation bolts and locking nuts, a lower end of the rack is fixedly connected to a ground through the foundation bolts and the locking nuts.

The invention has the following technology features over the prior art:

The invention provides an apparatus for repairing wheel tread with material increase, which implements the process of repairing wheel tread with material increase by arranging the wheels below the semicircular notch of the case and locating eccentrically the wheels relative to the semicircular notch; obtaining semisolid slurry by heating the ingot blank through the ingot blank heating device, and transporting the semisolid slurry into the agitation and output device for agitating the semisolid slurry, and outputting it to a worn portion of the wheels; meanwhile, heating the worn portion of the wheels by the wheel heating device, driving the wheels to rotate in the semicircular notch by the drive device, thus striking off redundant slurry from the wheels by the edge of the semicircular notch located eccentrically. The above process can avoid the size of the wheels from becoming smaller and being scrapped due to repairing the wheels, and is beneficial to save materials and is time-saving and labor-saving since the whole repair process is automatically carried out.

### BRIEF DESCRIPTION OF THE DRAWINGS

In order to more clearly illustrate the embodiments of the invention or the technical schemes in the prior art, the drawings required in the embodiments will be briefly described below, it is obvious that the drawings in the following description are only some embodiments of the invention, for those skilled in the art, other drawings can be obtained according to the drawings without inventive labors.

FIG. 1 is a front view of the apparatus for repairing wheel tread with material increase according to the present invention;

FIG. 2 is a right side view of the apparatus for repairing wheel tread with material increase according to the present invention.

Wherein: 1—rack; 2—slide rail; 3—base; 4—pedestal bearing; 5—wheel; 6—case; 7—support springs; 8—stud; 9—positioning nut; 10—heating furnace; 11—agitation and extrusion tank; 12—gearbox; 13—agitation and extrusion threaded rod; 14—handle; 15—bolt; 16—laser heating device; 17—foundation bolt; 18—locking nut; 19—discharge port; 20—wheel locking nut; 21—transmission shaft; 22—coupler; 23—motor; 24—motor support.

### DETAILED DESCRIPTION OF THE EMBODIMENTS

The technical schemes in the embodiments of the present invention will be clearly and completely described below combining with the accompanying drawings in the embodiments of the present invention, and it is obvious that the embodiments described are only a part of the embodiments of the present invention, and not all of them. All other embodiments, which are obtained by a person skilled in the art based on the embodiments of the present invention without inventive labors, shall fall within the protection scope of the present invention.

The invention aims to provide an apparatus for repairing wheel tread with material increase, which is used for solving the problems existing in the prior art, can avoid the size of the wheel from becoming smaller and being scrapped, saving materials, and is time-saving and labor-saving since the repair process is automatically carried out.

In order to make the above purposes, features and advantages of the present invention more comprehensible, the present invention is further and detailedly described combining with the accompanying drawings and specific embodiments thereof.

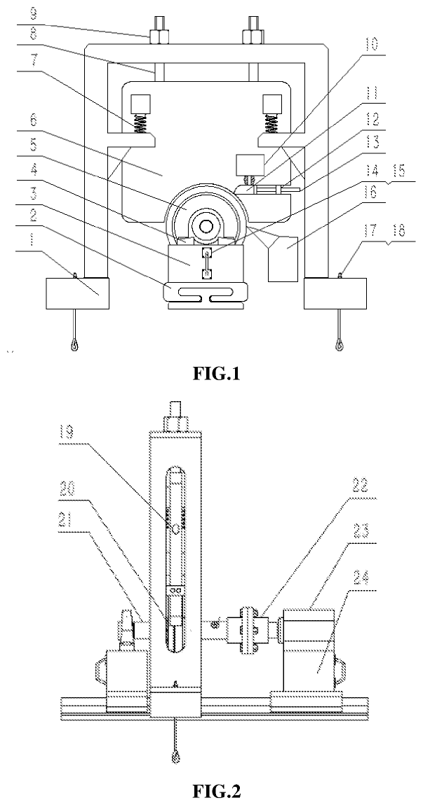

As shown in FIGS. 1-2, the embodiment provides an apparatus for repairing wheel tread with material increase, which comprises a slide rail 2, a rack 1, a case 6, a support device, a drive device, a wheel heating device, an ingot blank heating device and a agitation and output device. The slide rail 2 is fixedly arranged on a ground, the rack 1 is fixedly arranged above the slide rail 2, an upper end of the case 6 is fixedly connected to an upper portion of the rack 1, the support device for supporting wheel 5 and the drive device are both slidably connected to the slide rail 2, an output end of the drive device is fixedly connected to the wheel 5 to drive the wheel 5 to rotate. the wheel heating device is fixedly arranged below the case 6 and is used for heating a worn portion of the wheel 5. The ingot blank heating device and the agitation and output device are both fixedly arranged in the case 6, the case 6 plays a role of heat preservation to prevent a semisolid slurry from being solidified due to temperature reduce. The ingot blank heating device is used for heating an ingot blank and is communicated with the agitation and output device which agitates the slurry and extrudes the semisolid slurry toward the worn portion of the wheel 5. The case 6 is provided at its lower portion with a semicircular notch. the wheel 5 are located below the semicircle notch, and are arranged eccentrically relative to the semicircle notch so that clearances between various sites located at a peripheral edge of wheel 5 and the semicircle notch are different in size, thus the semicircle notch can strike off redundant slurry from the wheel 5 while the wheel 5 is rotating, thereby the process of repairing wheel tread with material increase is completed. The above process can avoid the size of the wheel from becoming smaller and being scrapped due to repairing the wheel, and the whole process is time-saving and labor-saving, since the whole repair process is automatically carried out.

The supporting device comprises a base 3 connected slidably to the slide rail 2, a pedestal bearing 4 arranged fixedly on the base 3, and a transmission shaft 21, one end of the transmission shaft 21 is engaged with the pedestal bearing 4 by an interference fit, the wheels 5 is fixed to the transmission shaft 21 through wheel locking nut 20, another end of the transmission shaft 21 fixedly connected to output end of the drive device which drives the transmission shaft 21 to rotate wheels 5.

The supporting device further comprises a handle 14 and screws 15, the handle 14 is fixedly connected to a front portion of the base 3 through the screws 15.

The drive device comprises a motor support 24 connected slidably to the slide rail 2, a motor 23 arranged fixedly on the motor support 24, and a coupler 22, a motor shaft of the motor 23 is fixedly connected to one end of the coupler 22, and another end of the coupler 22 is fixedly connected to one end of the transmission shaft 21 far away from the pedestal bearing 4.

The wheel heating device is a laser heating device 16.

The ingot blank heating device is a heating furnace 10.

The agitation and output device comprises a agitation and extrusion tank 11, a agitation and extrusion threaded rod 13 and a agitation drive device. The agitation and extrusion tank 11 and the agitation drive device are both fixedly arranged in the case 6. The agitation and extrusion threaded rod 13 is fixedly arranged inside the agitation and extrusion tank 11, and the agitation drive device is connected with the agitation and extrusion threaded rod 13 for driving it to rotate. A bottom surface of the agitation extrusion case 11 defines an extrusion port, an upper surface of the semicircular notch defines a discharge port 19 located at a position corresponding to the extrusion port. In addition, the agitation and extrusion threaded rod 13 is the twin threaded rods, and thereby can improve stirring efficiency and control extrusion direction.

The agitation drive device comprises an agitation motor 23 connected fixedly with an input end of a gearbox 12, and the gearbox 12. An output end of the gearbox 12 is fixedly connected to the agitation and extrusion threaded rod 13.

An apparatus for repairing wheel tread with material increase further comprises an adjusting device, which includes studs 8, positioning nuts 9 and support springs 7, one end of the studs 8 are fixedly connected to an outer top surface of the case 6, an upper portion of rack 1 defines bolt holes through which a free end of the studs 8 passes to connect with the positioning nuts 9. One end of support springs 7 are fixedly connected to a crossbeam located at the middle of the rack 1, and another end of which are used for being in contact with connection blocks provided fixedly on the case 6. The gap between the semicircular notch and the outer edge of the wheels 5 is adjusted by controlling a position of the positioning nuts 9 located at the studs 8 and a compression degree of the support springs 7.

The apparatus for repairing wheel tread with material increase further includes foundation bolts 17 and locking nuts 18, a lower end of the rack 1 is fixedly connected to a ground through the foundation bolts 17 and the locking nuts 18.

The principle and the implementation mode of the present invention are explained by using specific examples in the present specification, and the above description of the embodiments is only used to help understand the method and the core idea of the present invention; meanwhile, for a person skilled in the art, it may be changed in the specific embodiments and the application range according to the idea of the present invention. In conclusion, the contents of the description should not be construed as limitations on the invention.

What is claimed is:

1. An apparatus for repairing wheel tread with material increase, comprising a slide rail, a rack, a case, a supporting device, a drive device, a wheel heating device, an ingot blank heating device and an agitation and output device; wherein the slide rail is fixedly arranged on a ground, the rack is fixedly arranged above the slide rail, an upper end of the case is fixedly connected to an upper portion of the rack, the supporting device for supporting wheels and the drive device are both slidably connected to the slide rail, an output end of the drive device is fixedly connected to the wheels to drive the wheels to rotate; the wheels are positioned below a semicircular notch formed in a lower portion of the case, and are located eccentrically relative to the semicircular notch; the wheel heating device is fixedly arranged below the case and is used for heating a worn portion of the wheels, the ingot blank heating device and the agitation and output device are both fixedly arranged in the case, the ingot blank heating device is used for heating an ingot blank and is communicated with the agitation and output device for agitating slurry and extruding the slurry in a semisolid state toward the worn portion of the wheels.

2. The apparatus for repairing wheel tread with material increase according to claim 1, wherein the supporting device comprises a base connected slidably to the slide rail, a pedestal bearing arranged fixedly on the base, and a transmission shaft, one end of the transmission shaft is engaged with the pedestal bearing by an interference fit, the wheels is fixedly arranged on the transmission shaft, another end of the transmission shaft fixedly connected to an output end of the drive device.

3. The apparatus for repairing wheel tread with material increase according to claim 2, wherein the supporting device further comprises a handle and screws, the handle is fixedly connected to a front portion of the base through the screws.

4. The apparatus for repairing wheel tread with material increase according to claim 2, wherein the drive device comprises a motor support connected slidably to the slide rail, a motor arranged fixedly on the motor support, and a coupler, a motor shaft of the motor is fixedly connected to one end of the coupler, and another end of the coupler is fixedly connected to one end of the transmission shaft far away from the pedestal bearing.

5. The apparatus for repairing wheel tread with material increase according to claim 1, wherein the wheel heating device is a laser heating device.

6. The apparatus for repairing wheel tread with material increase according to claim 1, wherein the ingot blank heating device is a heating furnace.

7. The apparatus for repairing wheel tread with material increase according to claim 1, wherein the agitation and output device comprises a agitation and extrusion tank, a agitation and extrusion threaded rod and a agitation drive device; the agitation and extrusion tank and the agitation drive device are both fixedly placed in the case, the agitation and extrusion threaded rod is fixedly arranged inside the agitation and extrusion tank, and is connected with the agitation drive device for driving the agitation and extrusion threaded rod to rotate, a bottom surface of the agitation and extrusion tank defines an extrusion port, an upper surface of the semicircular notch defines a discharge port located at a position corresponding to the extrusion port.

8. The apparatus for repairing wheel tread with material increase according to claim 7, wherein the agitation drive device comprises an agitation motor connected fixedly with an input end of a gearbox and the gearbox, an output end of the gearbox is fixedly connected to the agitation and extrusion threaded rod.

9. The apparatus for repairing wheel tread with material increase according to claim 1, further comprises an adjusting device comprising studs, positioning nuts and support springs, one end of the studs are fixedly connected to an outer top surface of the case, an upper portion of rack defines bolt holes through which a free end of the studs threadedly connected to the positioning nuts passes, one end of support springs are fixedly connected to a crossbeam located at the middle of the rack, and another end of which are used for being in contact with connection blocks arranged fixedly on the case.

10. The apparatus for repairing wheel tread with material increase according to claim 1, further comprises foundation bolts and locking nuts, a lower end of the rack is fixedly connected to a ground through the foundation bolts and the locking nuts.
